(19) United States
(12) Patent Application Publication
(10) Pub. No.: US 2009/0074227 A1
(43) Pub. Date: Mar. 19, 2009

(54) CRIMPING TINSEL LEADS

(76) Inventor: G. STEWART RENNER, Sudbury, MA (US)

Correspondence Address: FISH & RICHARDSON PC, P.O. BOX 1022, MINNEAPOLIS, MN, 55440-1022, US

(21) Appl. No.: 11/856,250

(22) Filed: Sep. 17, 2007

(51) Int. Cl. H04R 9/06

(52) U.S. Cl. 381/409

(57) ABSTRACT

A voice coil lead and a tinsel lead are connected to a conductive element, which has a first crimp connected to the voice coil lead and a second crimp connected to the tinsel lead. The crimps are arranged to impede a moisture path from the tinsel lead to the voice coil lead.

### TECHNICAL FIELD

This disclosure relates to crimping tinsel leads.

### BACKGROUND

As shown in FIG. 1A, a tinsel lead 108, a braid of flexible wire coated with silver, is electrically connected to a voice coil of a speaker (not shown) through an aluminum voice coil lead 104 within a single crimp 106 of; for example, tin-plated brass. Moisture can wick along a moisture path 103 within the braid of the tinsel lead 108 by capillary action, causing salt, an electrolyte, to enter the joint 107 through the tinsel lead 108. The salt facilitates ion migration, the flow of electrons between the tinsel lead 108 and the voice coil lead 104, because of the different galvanic potentials between the aluminum of the voice coil lead 104 and the silver of the tinsel lead 108, creating a galvanic cell and causing corrosion of the aluminum.

In one example, to reduce such wicking, the crimp 106, as shown in FIGS. 1B and 1C, is soldered to a copper pad 110 and is electrically connected to the voice coil lead 104. The tinsel lead 108 is soldered to the copper pad 110 to electrically, but not mechanically, connect the tinsel lead 108 to the voice coil lead 104. The copper pad 110 may be attached to a voice coil bobbin 105. Mechanical separation of the tinsel lead 108 and the voice coil lead 104 reduces ion migration from the tinsel lead 108 to the voice coil lead 104 and corrosion of the aluminum.

### SUMMARY

In general, in one aspect, a connecting element for a loudspeaker electrically connects a voice coil lead and a tinsel lead in a manner that impedes a moisture path between the leads (e.g., by maintaining a physical gap between the leads).

In general, in another aspect, a voice coil lead and a tinsel lead are connected to a conductive element, which has a first crimp connected to the voice coil lead and a second crimp connected to the tinsel lead. The crimps are arranged to impede a moisture path from the tinsel lead to the voice coil lead.

Implementations may include one or more of the following. The first crimp and the second crimp maintain a gap between the tinsel lead and the voice coil lead. The first crimp and the second crimp prevent moisture from migrating between the tinsel lead and the voice coil lead. The first crimp and the second crimp are electrically connected. The first crimp and the second crimp are mechanically separated. The voice coil lead is connected to a voice coil. The voice coil and the voice coil lead are sealed. The voice coil and the voice coil lead are sealed by glue. The conductive element is attached to a speaker cone. The speaker cone is inverted relative to the voice coil. The conductive element comprises tin-plated brass. The voice coil lead comprises aluminum. The conductive element comprises a wire connecting the first crimp to the second crimp.

In general, in one aspect, a speaker has a voice coil lead, a tinsel lead, and a conductive element. The conductive element has a first crimp connected to the voice coil lead and a second crimp connected to the tinsel lead. The crimps are arranged to impede a moisture path from the tinsel lead to the voice coil lead.

In general, in one aspect, a vehicle (e.g., automobile, motorcycle, watercraft, etc.) has a speaker that has a voice coil lead, a tinsel lead, and a conductive element. The conductive element has a first crimp connected to the voice coil lead and a second crimp connected to the tinsel lead. The crimps are arranged to impede a moisture path from the tinsel lead to the voice coil lead.

Advantages include a more compact implementation that requires less labor, contains less mass, and has improved performance and environmental stability over previous methods.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a cross-section of a single crimp of a voice coil lead and a tinsel lead.

FIGS. 1B and 1C are a front view and a side view of a voice coil lead connected to a tinsel lead.

FIG. 2A is an exterior side view of a dual-crimp.

FIG. 2B is an isometric view of a dual-crimp.

FIGS. 2C and 5 are cross-sections of a dual-crimped voice coil lead and tinsel lead.

FIG. 2d is an isometric view of a dual-crimped voice coil lead and tinsel lead.

FIGS. 3A, 3B and 3C are cross sections showing dual-crimps attached to speaker cones.

FIG. 4 is a cross-section of a intermediate lead crimped to a voice coil lead and a tinsel lead.

### DETAILED DESCRIPTION

Galvanic corrosion is reduced by crimping the voice coil lead to one crimp and the tinsel lead to another crimp, each crimp included in a single conductive element, such that the crimps impede a moisture path from the tinsel lead to the voice coil lead.

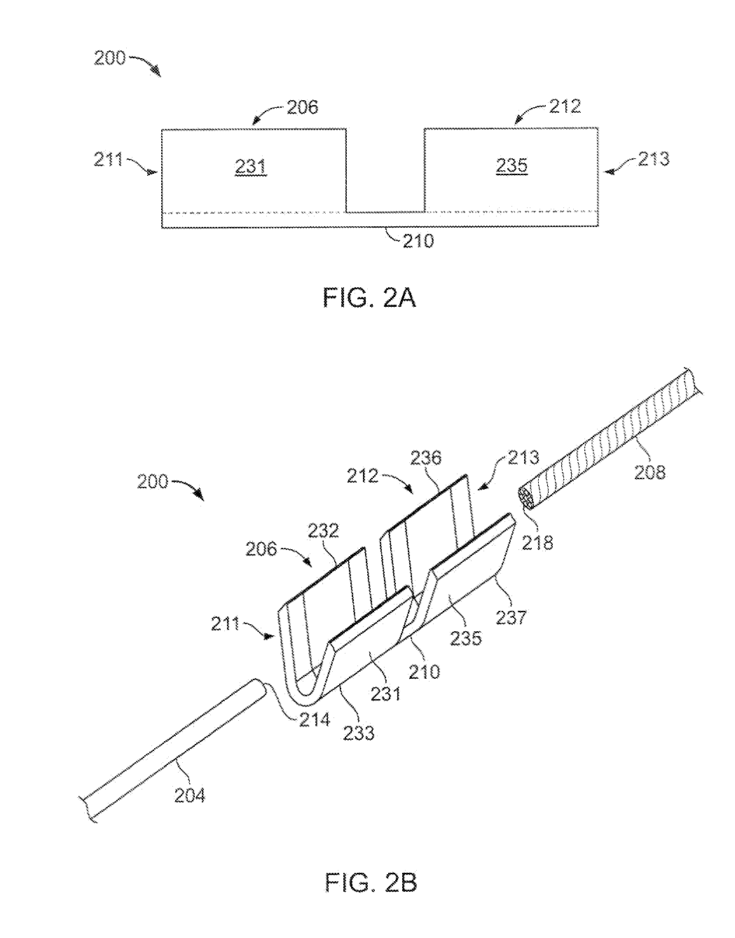

For example, as shown in FIGS. 2A, 2B, 2C, and 2d, a dual-crimp 200 includes a first crimp 206 and a second crimp 212, each made of tin-plated brass, and a neck 210 that mechanically connects the first crimp 206 and the second crimp 212. An exposed tip 214 of a voice coil lead 204 and an exposed tip 218 of a tinsel lead 208 are inserted into opposite ends 211 and 213 of the dual-crimp 200, as shown in FIG. 2B, deliberately leaving a gap 216 (FIG. 2C) between the tips 214 and 218 after insertion. To hold the voice coil lead 204 and the tinsel lead 208 in the dual-crimp 200, sides 231 and 232 of the first crimp 206 are tightly wrapped inwardly from a base 233 and sides 235 and 236 of the second crimp 212 are tightly wrapped inwardly from a base 237, forming the closed forms of the crimps 206 and 212 shown in FIGS. 2C and 2d. In some examples, both crimps are formed in a single crimping operation. The neck 210 electrically connects the first crimp 206 and the second crimp 212 while maintaining their mechanical separation, which impedes the moisture and salt drawn in by the tinsel lead 208 from reaching the aluminum voice coil lead 204, reducing the flow of metallic ions between the two dissimilar materials of the voice coil lead 204 and tinsel lead 208.

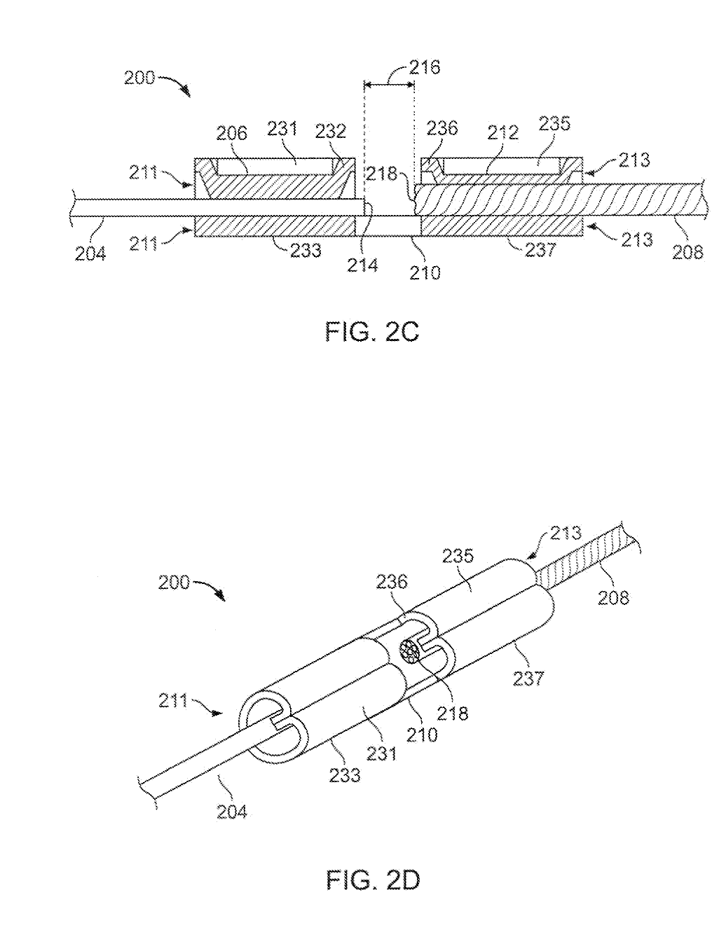

In some examples, as shown in FIGS. 3A, 3B, and 3C, the dual-crimp 200 can be attached to a speaker cone 302, of a speaker 300. In the example of FIG. 3A, the voice coil lead 204 exits a conventional voice coil housing 304 into the open space 306 of a conventionally-oriented speaker cone 302. The dual crimp 200 electrically connects the voice coil lead 204 to the tinsel lead 208 and is adhered to the inside face 308 of the cone 302. The leads and crimps may also be attached to the back side 310 of the cone 302, as shown in FIG. 3B. In the examples of FIGS. 3B and 3C, the speaker cone 302 is inverted relative to the voice coil housing 304. The dual crimp 200 may be adhered to the outside face 310 of the cone 302, as in FIG. 3B, if the voice coil lead 204 exits through the base of the cone 302, or to the inside face 308 if the voice coil lead 204 remains inside the cone 302, as in FIG. 3C.

In some examples, the voice coil lead 204, first crimp 206, and at least part of the neck 210 are sealed with, for example, glue 312 (only shown in FIG. 3A), which further impedes moisture or salt from passing from the tinsel lead 208 to the voice coil lead 204, protecting against corrosion and preserving the life of the speaker 300. Preventing such corrosion is advantageous, for example, when the speaker 300 is installed outdoors or in a vehicle 314, such as an automobile, motorcycle, or watercraft where the speaker 300 is likely to be exposed to salt and moisture.

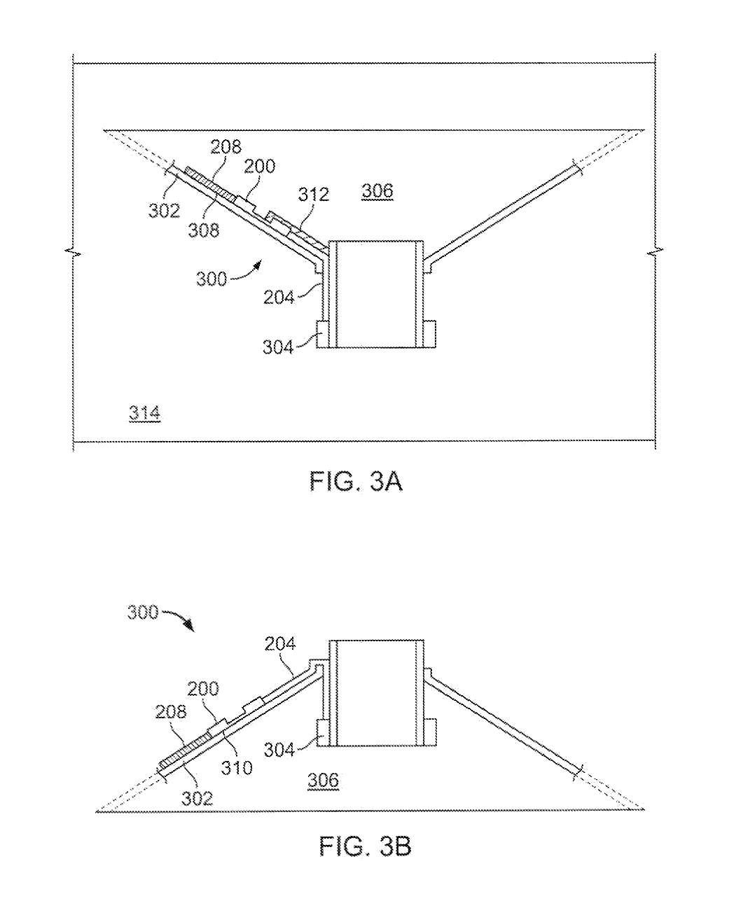

In some examples, such as the one shown in FIG. 4, the connecting mechanism includes two separate crimps for each lead that are joined via a separate conductive element. In particular, a first crimp 406 crimps the voice coil lead 204 to a tip 402 of a strand of solid copper wire 404 and a second crimp 412 crimps the tinsel lead 208 to a second tip 408 of the copper wire 404, leaving a gap between the copper wire 404 and each of the leads 204, 208.

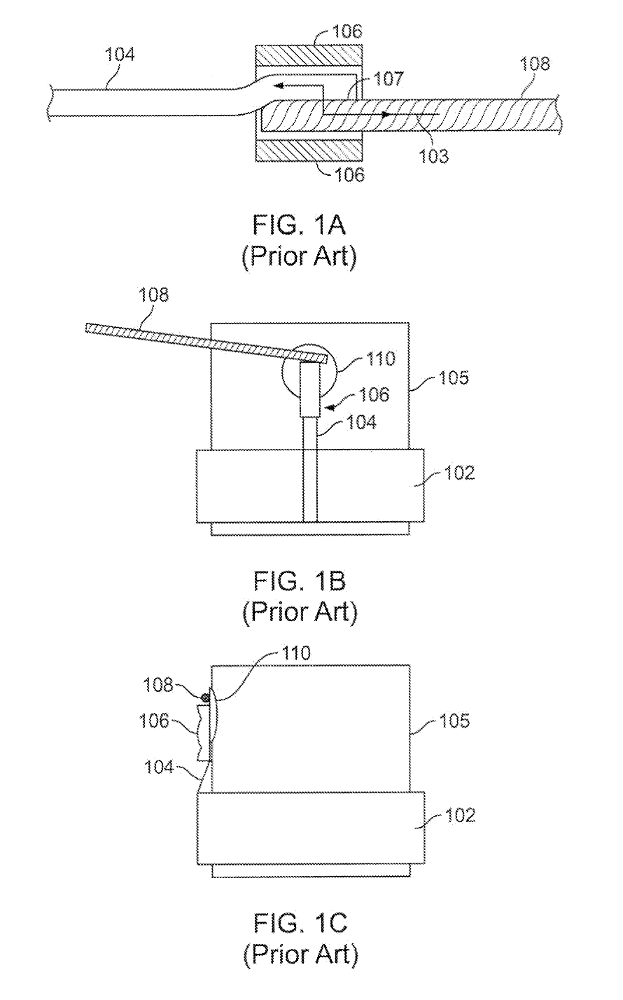

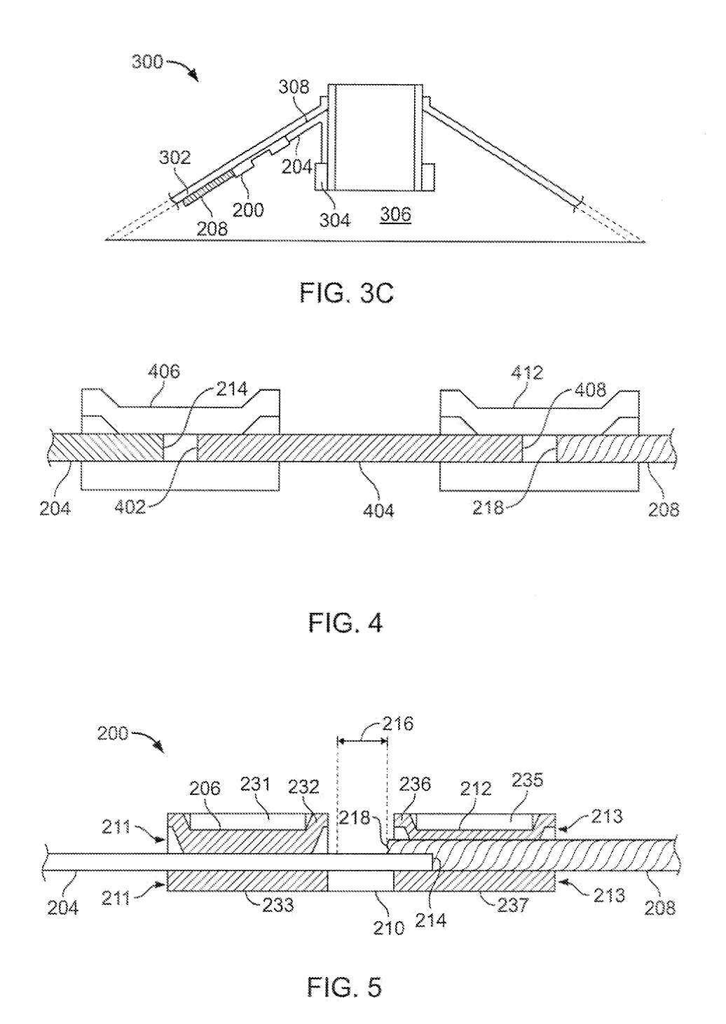

In some examples, as shown in FIG. 5, the dual crimp 200 is as in the example of FIG. 2A-2D, but the voice coil lead 204 extends into the second crimp 212, making contact with the tinsel lead 208 (as shown for a single crimp in FIG. 1A). Corrosion may occur at the interface between the voice coil lead 204 and the tinsel lead 208 within the second crimp 212, but once the voice coil lead 204 has corroded to a point within the gap 216, the structure will be as shown in FIGS. 2C and 2D. At this point, voice coil lead 204 will no longer be in contact with the tinsel lead 208. The moisture path 103 will be broken and corrosion of the voice coil lead 204 will stop. Because the separate first crimp 206 retains an un-corroded section of the voice coil lead 204, the electrical connection between the voice coil lead 204 and the tinsel lead 208 is not interrupted.

Various metals and alloys may be used for the dual crimp 200 or for separate crimps 406, 412 and connecting wire 404. The choice of metal depends on the metals used for the tinsel lead 208 and voice coil lead 204 and the environment the speaker are expected to be exposed to. In some examples, as mentioned above, tin-plated brass is used for the crimps.

Other implementations are within the scope of the following claims.

1. An apparatus comprising:
a voice coil lead;
a tinsel lead; and
a conductive element having a first crimp connected to said voice coil lead and having a second crimp connected to said tinsel lead, said crimps arranged to impede a moisture path from said tinsel lead to said voice coil lead.

2. The apparatus of claim 1, wherein said first crimp and said second crimp maintain a gap between said tinsel lead and said voice coil lead.

3. The apparatus of claim 1, wherein
a first portion of said voice coil lead is in contact with said tinsel lead, and
a second portion of said voice coil lead is in contact with said first crimp,
such that if the first portion of said voice coil lead were absent, a gap would exist between said tinsel lead and said second portion of said voice coil.

4. The apparatus of claim 1, wherein
a first portion of said voice coil lead is in contact with said tinsel lead, and
a second portion of said voice coil lead is in contact with said first crimp,
such that said moisture path extends from said tinsel lead to said first portion of said voice coil lead and does not extend to said second portion of said voice coil lead.

5. The apparatus of claim 1, wherein said first crimp and said second crimp prevent moisture from migrating between said tinsel lead and said voice coil lead.

6. The apparatus of claim 1, wherein said first crimp and said second crimp are electrically connected.

7. The apparatus of claim 1, wherein said first crimp and said second crimp are mechanically separated.

8. The apparatus of claim 1, wherein said voice coil lead is connected to a voice coil.

9. The apparatus of claim 1, wherein said first crimp connected to said voice coil lead is sealed.

10. The apparatus of claim 9, wherein said first crimp is sealed by glue.

11. The apparatus of claim 1, wherein said conductive element is attached to a speaker cone.

12. The apparatus of claim 9, wherein the speaker cone is inverted relative to the voice coil.

13. The apparatus of claim 1, wherein said conductive element comprises tin-plated brass.

14. The apparatus of claim 1, wherein said voice coil lead comprises aluminum.

15. The apparatus of claim 1, wherein said conductive element comprises a wire connecting the first crimp to the second crimp.

16. A method for separating a voice coil lead and a tinsel lead, comprising:
crimping a conductive element to said voice coil lead;
crimping the conductive element to said tinsel lead; and
impeding a moisture path from said tinsel lead to said voice coil lead.

17. The method of claim 16, wherein impeding the moisture path comprises maintaining a gap between said tinsel lead and said voice coil lead.

18. The method of claim 16, wherein impeding the moisture path comprises preventing moisture from migrating between said tinsel lead and said voice coil lead using said first crimp and said second crimp.

19. The method of claim 16, also comprising electrically connecting said first crimp and said second crimp.

20. The method of claim 16, wherein impeding the moisture path comprises mechanically separating said first crimp and said second crimp.

21. The method of claim 16, also comprising connecting said voice coil lead to a voice coil.

22. The method of claim 16, also comprising sealing a joint formed by crimping said conductive element to said voice coil lead.

23. The method of claim 22, also comprising sealing said joint with glue.

24. The method of claim 16, also comprising attaching said conductive element to a speaker cone.

25. The method of claim 24, wherein the speaker cone is inverted relative to a voice coil.

26. The method of claim 16, wherein said conductive element comprises tin-plated brass.

27. The method of claim 16, wherein said voice coil lead comprises aluminum.

28. The method according to claim 16, wherein crimping a conductive element to said voice coil lead and crimping the conductive element to said tinsel lead are performed as a single crimping operation.

29. The method of claim 16, wherein said conductive element comprises a wire connecting the first crimp to the second crimp.

30. A system comprising:
a speaker having a voice coil lead;
a tinsel lead; and
a conductive element having a first crimp connected to said voice coil lead and having a second crimp connected to said tinsel lead, said crimps arranged to impede a moisture path from said tinsel lead to said voice coil lead.

31. The system of claim 30 wherein the speaker is integrated into a vehicle.

32. The system of claim 31 wherein the vehicle is an automobile.

33. An apparatus comprising:
a vehicle having a speaker having a voice coil lead;
a tinsel lead; and
a conductive element having a first crimp connected to said voice coil lead and having a second crimp connected to said tinsel lead, said crimps arranged to impede a moisture path from said tinsel lead to said voice coil lead.
